(19) United States
(12) Patent Application Publication
(10) Pub. No.: US 2023/0137487 A1
(43) Pub. Date: May 4, 2023

(54) SYSTEM FOR IDENTIFICATION OF WEB ELEMENTS IN FORMS ON WEB PAGES

(71) Applicant: Klarna Bank AB, Stockholm (SE)

(72) Inventors: David Buezas, Berlin (DE); Riccardo Sven Risuleo, Stockholm (SE); Theodoros Papathanasiou, Stockholm (SE); Albert Nigmatzianov, Stockholm (SE)

(21) Appl. No.: 17/967,811

(22) Filed: Oct. 17, 2022

Related U.S. Application Data
(60) Provisional application No. 63/273,822, filed on Oct. 29, 2021.
(60) Provisional application No. 63/273,824, filed on Oct. 29, 2021.
(60) Provisional application No. 63/273,852, filed on Oct. 29, 2021.

(51) Int. Cl. G06F 40/174; G06F 16/958; G06N 5/02; G06F 40/284; G06F 40/143

(52) U.S. Cl. CPC G06F 40/174; G06F 16/986; G06N 5/022; G06F 40/284; G06F 40/143

(57) ABSTRACT

Source code of a form element of a web form and a predetermined data classification of the form element is obtained. A vector is generated based at least in part on a transformation of a set of keywords derived from the source code. A machine learning model is trained to predict data categories of form elements by providing, to the machine learning model, the predetermined data classification and the vector.

### CROSS REFERENCE TO RELATED APPLICATIONS

This application claims the benefit of U.S. Provisional Patent Application No. 63/273,822, filed Oct. 29, 2021, entitled “SYSTEM FOR IDENTIFICATION OF WEB ELEMENTS IN FORMS ON WEB PAGES,” U.S. Provisional Patent Application No. 63/273,824, filed Oct. 29, 2021, entitled “METHOD FOR VALIDATING AN ASSIGNMENT OF LABELS TO ORDERED SEQUENCES OF WEB ELEMENTS IN A WEB PAGE,” and U.S. Provisional Patent Application No. 63/273,852, filed Oct. 29, 2021, entitled “EFFICIENT COMPUTATION OF MAXIMUM PROBABILITY LABEL ASSIGNMENTS FOR SEQUENCES OF WEB ELEMENTS,” the disclosures of which are herein incorporated by reference in their entirety.

This application incorporates by reference for all purposes the full disclosure of co-pending U.S. patent application Ser. No. ______, filed concurrently herewith, entitled “A METHOD FOR VALIDATING AN ASSIGNMENT OF LABELS TO ORDERED SEQUENCES OF WEB ELEMENTS IN A WEB PAGE” (Attorney Docket No. 0101560-024US0), and co-pending U.S. patent application Ser. No. ______, filed concurrently herewith, entitled “EFFICIENT COMPUTATION OF MAXIMUM PROBABILITY LABEL ASSIGNMENTS FOR SEQUENCES OF WEB ELEMENTS” (Attorney Docket No. 0101560-025US0).

### BACKGROUND

Automatic form filling is an attractive way of improving a user's experience while using an electronic form. Filling in the same information, such as name, email address, phone number, age, credit card information, and so on, in different forms on different websites over and over again can be quite tedious and annoying. Forcing users to complete forms manually can result in users giving up in frustration or weariness and failing to complete their registration or transaction.

Saving once-filled-in form information for reusing it later when new forms are encountered on newly visited websites, however, presents its own set of problems. Since websites are built in numerous different ways (e.g., using assorted web frameworks), it is difficult to automatically identify the field classes in order to map the fields to the correct form information for that field class. Furthermore, some websites take measures to actively confuse browsers so they do not memorize entered data. For instance, a form-filling system needs to detect whether a web page includes forms, identify the kind of form fields within it, and decide on the information (from the previously filled in and stored list) that should be provided. However, these all look different depending on the information required from the user, the web frameworks used, and the particular decisions taken by its implementers.

### BRIEF DESCRIPTION OF THE DRAWINGS

Various techniques will be described with reference to the drawings, in which:

FIG. 1 illustrates an example of form filling using a local assignment module in accordance with an embodiment;

FIG. 2 illustrates an example of form filling using a local assignment module in accordance with an embodiment;

FIG. 3 illustrates an example of transforming features of an interface into a feature vector in accordance with an embodiment;

FIG. 4 is a flowchart that illustrates an example of transforming features of an interface into a feature vector in accordance with an embodiment;

FIG. 5 illustrates an example of a data table of training data in accordance with an embodiment;

FIG. 6 is a flowchart that illustrates an example of training a machine learning model to classify interface object classes in accordance with an embodiment; and

FIG. 7 illustrates a computing device that may be used in accordance with at least one embodiment.

### DETAILED DESCRIPTION

Techniques and systems described below relate to solutions for problems of identifying input elements in forms within web pages. In one example, HyperText Markup Language (HTML) code of a form element in a web page and a classification of the element are obtained. The HTML code of the element is tokenized to produce a feature vector, which represents which keywords of a set of possible keywords are present within the HTML code of the element. Further in the example, a trained machine learning model is produced by providing, to a supervised machine learning model, the classification of the element as label input, and by providing, to the supervised machine learning model, the vector as input.

In an embodiment, the system of the present disclosure scans an interface to generate a list of keywords (also referred to as a “bag of words” or BoW). In the embodiment, an operator identifies elements of interest (e.g., form fields and/or other HTML objects) and their classes (e.g., first name field, middle initial field, last name field, address field, city field, zip code field, card verification value field, add to cart button, ordered list object, unordered list object, link, etc.). This data then may be used as a set of training data to train a machine learning model to identify such elements of interest and predict their element class. For example, a set of features for an element of interest may be derived from the list of keywords as described in further detail herein, and the set of features may be tokenized/transformed into a feature vector suitable for input to the machine learning model (with the element class for the element of interest having been identified by a human operator as the ground truth label for the element of interest). During the training, certain features may be identified as having the most relevance in determining the element class of an element of interest. For example, out of the entire set of keywords, the system and/or human operator may identify the top 500 keywords that appear to have the most bearing on distinguishing one element class from another. Thereafter, in some embodiments, the system of the present disclosure may only scan the interface for the presence of those top keywords and ignore the remainder.

Once the machine learning model is trained, the system may identify elements of interest in an arbitrary interface, and, for each element of interest, a feature vector may be derived in the same manner as during the training from a set of keywords (e.g., from HTML code or text surrounding or within the element of interest) of the arbitrary interface and provided to the trained machine learning model as input. The trained machine learning model may then output confidence scores for element classes observed during training (either a confidence score for each element class or a confidence score for each of the top N element classes, where N is a fixed number), where the confidence score indicates a probability that the element of interest corresponds to the respective element class.

The techniques and systems of the present disclosure provide an advantage over systems that use hard-coded rules to identify form field classes at least in that the techniques and systems of the present disclosure can accurately identify elements of interest and determine their element class regardless of the language the interface is written in because among the numerous features from which the machine learning model of the present disclosure is trained, can be found features that are common to interfaces irrespective of origin. For example, many source code keywords may be in English even in regions where English is not a primary language. However, some classes of elements may not exist in all regions; for example, some regions may commonly have fields for a personal identification number, job title, or age, whereas other regions may lack such fields in most forms. Thus, the present disclosure contemplates that multiple machine learning models may easily be trained and implemented for different regions using separate sets of training data for the different regions in order to improve the form-filling accuracy for the different regions.

Techniques described and suggested in the present disclosure improve the field of computing, especially the field of electronic form filling, by reducing a very large set of features local to each form element to a token/vector that is suitable for input to a machine learning model trained to identify form element classes based on not necessarily intuitive features common to other form elements of the same class from disparate form providers. Additionally, techniques described and suggested in the present disclosure improve the speed of electronic form filling and improving user experience by enabling users to quickly complete and submit electronic forms with minimal user input. Moreover, techniques described and suggested in the present disclosure are necessarily rooted in computer technology in order to overcome problems specifically arising with accurately identifying form elements based on their individual features by utilizing machine learning trained to identify form elements classes from a variety of different features.

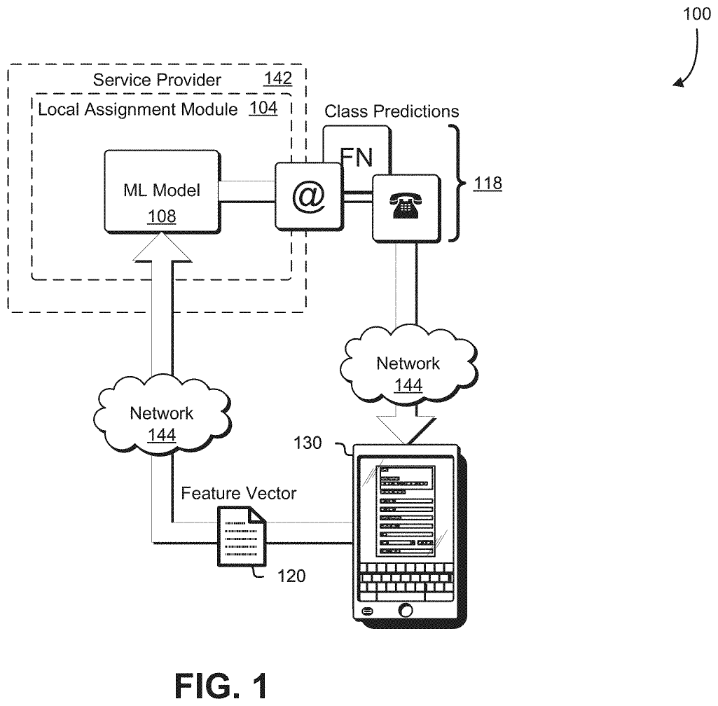

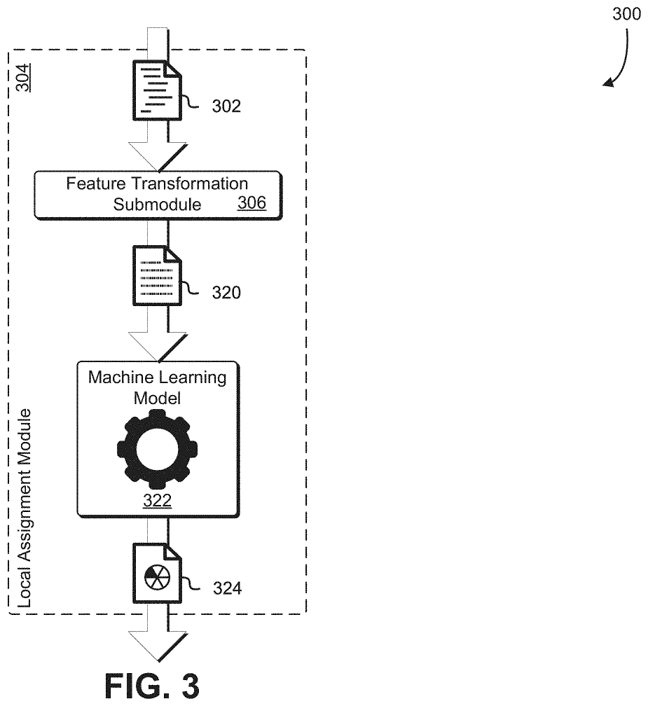

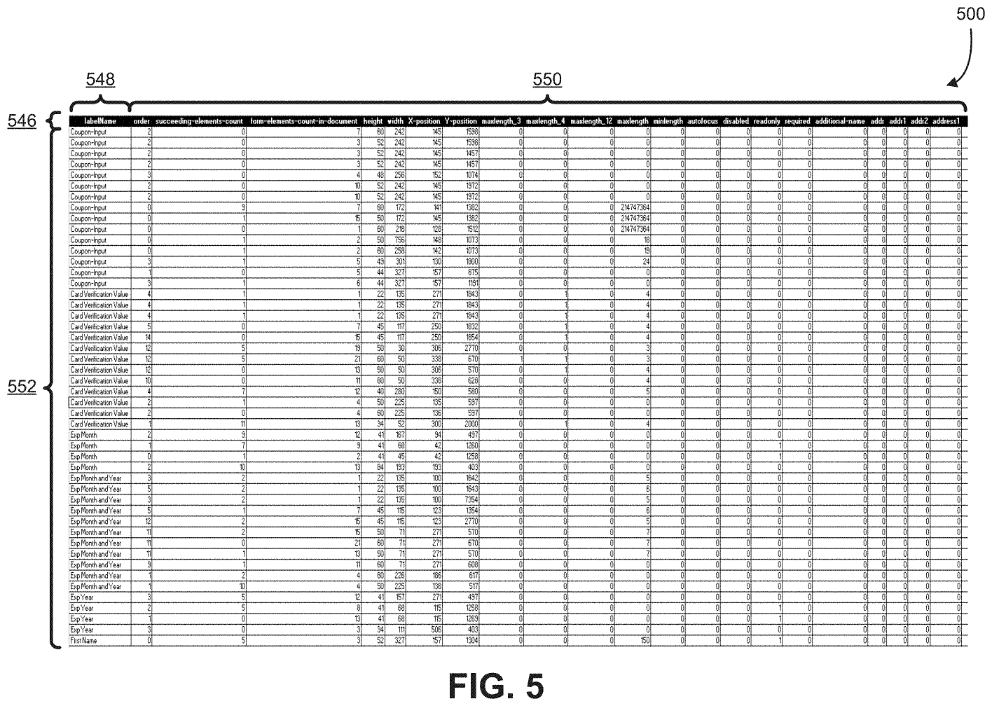

FIG. 1 illustrates an example 100 of form filling using a local assignment module of an embodiment of the present disclosure. Specifically, FIG. 1 depicts a local assignment module 104 of a service provider 142 that has been trained with training data, such as in the example data table 500 of FIG. 5, to recognize element classes. In this example 100, a client device 130 operated by a user is displaying an interface, and a form-filling process as described in the present disclosure, examines the interface for features and generates a feature vector 120 (such as the feature vector 320 described in FIG. 3) for each element of interest in the interface based on the features within the interface identified by the form-filling process. In some examples, a “client” refers to a computing device utilized by a user to access a service of a service provider, such as the local assignment module 104 of the service provider 142.

The client device 130 may send the feature vector 120 to the machine learning model 108 that has been trained to identify certain elements of interest. The machine learning model 108 may output the class predictions 118 for each of the elements of interest, which may be sent back to the client device 130 for use by a form-filling process in automatically completing data entry in one or more form elements of the interface on the client device 130. The data entry values (form-fill information) may be user-identifying information corresponding to the predicted classifications for the elements of interest. In some embodiments, the form-fill information is stored locally on the client device 130. In other implementations, the form-fill information is stored in a data store at the service provider 142. In some implementations, the service provider 142 may additionally send the information (e.g., first name, last name, address, city, zip code, etc.) that the client device 130 can use to auto-complete the form. Such personally identifiable information (PII) may be encrypted for security. In other implementations, the information usable by the client device 130 to auto-complete the form may be stored locally on the client device 130 itself (e.g., to reduce the chance of interception of PII).

The local assignment module 104 may be a classification model implemented in hardware or software capable of producing probabilistic predictions of element classes. Embodiments of this model could include a naive Bayes classifier, neural network, or a softmax regression model. The local assignment module 104 may receive information about elements of interest and output confidence scores for the elements indicating a probability of the elements belonging to a class from a predefined vocabulary of classes.

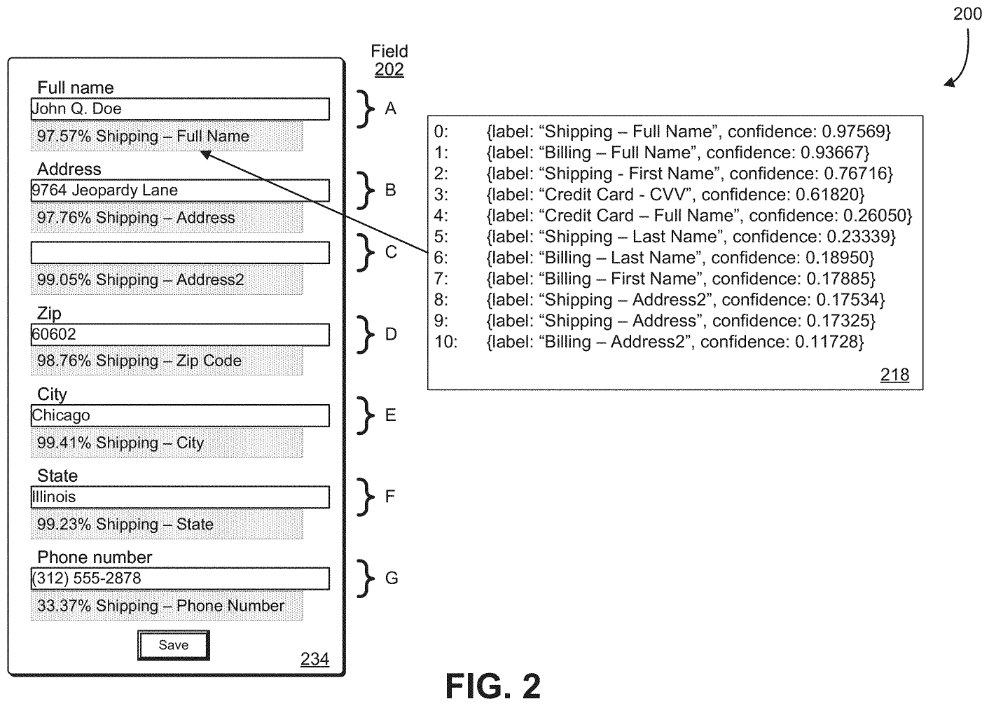

These confidence scores may be indicated in the class predictions 118. The class predictions 118 may be predictions of probability of an element of interest being a particular class. Note, however, that the use of “probability” in the context of the present disclosure may not necessarily refer to a statistical likelihood (e.g., the probability (density) of observations given a parameter). Rather, in some examples “probability” refers to an unnormalized probability (e.g., a relative score) that reflects mutual preferences between alternatives. The probabilities of the class predictions 118, for example, can be compared with each other to determine which class, in Bayesian interpretation, is more probable and therefore more preferable. The class predictions 118 may be a set of confidence scores in the set of label confidence scores 218 of FIG. 2. The mathematics used to generate the set of confidence scores may be similar to the rules of probability theory (but may lack a normalization constant; hence the term, “unnormalized probability”). Note, however, that it is contemplated that techniques of the present disclosure are usable with different scoring methods to indicate preference that may produce values not strictly regarded as unnormalized probabilities.

The local assignment module 104 may be trained in a supervised manner to, for an element of interest, return confidence scores for the element belonging to each class of interest from predefined classes of interest (e.g., name field, zip code field, city field, etc.) based on the information about element of interest (e.g., a tag, attributes, text contained within the element source code and immediate neighboring text elements, etc.). In some examples, an “element of interest” refers to an element of an interface that is identified as having potential to be an element that falls within a class of interest. In some examples, an “element” refers to an object incorporated into an interface, such as a HyperText Markup Language (HTML) element.

Examples of elements of interest include HTML form elements, list elements, or other HTML elements, or other objects occurring within an interface. In some examples, a “class of interest” refers to a particular class of element that an embodiment of the present disclosure is trained or being trained to identify. Examples of classes of interest include name fields (e.g., first name, middle name, last name, etc.), surname fields, cart button, total amount field, list item element, or whatever element is suitable to use with the techniques of the present disclosure as appropriate to the implemented embodiment. Further details about the local assignment module may be found in the descriptions of FIGS. 2-6. Information about the element of interest may include tags, attributes, or text contained within the source code of the element interest. Information about the element of interest may further include tags, attributes, or text contained within neighboring elements of the element of interest.

The local assignment module 104 may be trained on a corpus of labeled HTML elements to predict the probability (e.g., p(label|features)) of each HTML element being assigned a given set of labels. See labelName column 548 and feature columns 550 of FIG. 5. The local assignment module 104 may include a machine learning model 108 that has been trained, using a set of training data, to recognize classes of interface elements; for example, the set of training data may include interfaces, such as a set of web pages, which have elements of interest already determined and marked as belonging to a class (e.g., email, password, etc.), and this set of training data may be used to train the local assignment module 104 to identify the classes of elements of interest in interfaces that have not been previously observed by the local assignment module 104.

The set of training data may be a set of sample web pages, forms, and/or elements (also referred to as interface objects) stored in a data store. For example, each web page of the set of training data may be stored as a complete page, including their various elements, and each stored element and each web page may be assigned distinct identifiers (IDs). Elements of interest may be identified in the web page and stored separately with a reference to the original web page. The IDs may be used as handles to refer to the elements once they are identified (e.g., by a human operator) as being elements of interest. So, for example, a web page containing a shipping address form may be stored in a record in a data store as an original web page, and the form fields it contains such as first name, last name, phone number, address line 1, address line 2, city, state, and zip code may be stored in a separate table with a reference to the record of the original web page. If, at a later time, a new element of interest is identified—middle initial field, for example—the new element and the text surrounding it can be retrieved from the original web page and be added in the separate table with the reference to the original web page. In this manner, the original web pages are preserved and can continue to be used even as the elements of interest may evolve. In embodiments, the elements of interest in the set of training data are identified manually by an operator (e.g., a human).

Once the elements of interest are identified and stored as the training data, it may be used by a feature transformation submodule of the local assignment module 104 to train the machine learning model 108. The feature transformation submodule may generate/extract a set of features for each of the stored elements of interest. The set of features may include attributes of the interface object (e.g., name, value, ID, etc. of the HTML, element) or keywords or other elements near the interface object. For example, text of “CVV” near a form field may be a feature with a strong correlation to the form field being a “card verification value” field. Likewise, an image element depicting an envelope icon with a source path containing the word “mail” (e.g., “http://www.example.com/img/src/mail.jpg”) and/or nearby text with an “@” symbol (e.g., “johndoe@example.com”) may be suggestive of the interface object being a form field for entering an email address. Each interface object may be associated with multiple features that, in conjunction, allow the machine learning model to compute a probability indicating a probability that the interface object is of a certain class (e.g., card verification value field).

The feature transformation submodule may be a submodule of the local assignment module 104 that transforms source data from an interface, such as from the set of training data, into a feature vector. In embodiments, the feature transformation submodule may identify, generate, and/or extract features of an interface object, such as from attributes of the object itself or from nearby text or attributes of nearby interface objects as described above. In embodiments, the feature transformation submodule may transform (tokenize) these features into a format suitable for input to the machine learning model 108, such as the feature vector. For example, the feature transformation submodule may receive the HTML of the input object, separate the HTML into strings of inputs, normalize the casing (e.g., convert to lowercase or uppercase) of the inputs, and/or split the normalized inputs by empty spaces or certain characters (e.g., dashes, commas, semicolons, greater-than and less-than symbols, etc.). These normalized split inputs may then be compared with a dictionary of keywords known to be associated with elements of interest to generate the feature vector. For example, if “LN” (which may have a correlation with “last name” fields) is in the dictionary and in the normalized split inputs, the feature transformation submodule may append a “1” to the feature vector; if “LN” is not present in the normalized split inputs, the feature transformation submodule may instead append a “0” to the feature vector, and so on. Additionally or alternatively, the dictionary may include keywords generated according to a moving window of fixed-length characters. For example, “ADDRESS” may be transformed into three-character moving-window keywords of “ADD,” “DDR,” “DRE,” “RES,” and “ESS,” and the presence or absence of these keywords may result in a “1” or “0” appended to the feature vector respectively as described above. Note that “1” indicating presence and “0” indicating absence is arbitrary, and it is contemplated that the system may be just as easily implemented with “0” indicating presence and “1” indicating absence, or implemented using other values as suitable. This tokenized data may be provided as input to the machine learning model 108 in the form of the feature vector.

To train the machine learning model 108, the feature transformation submodule may produce a set of feature vectors from the set of training data, as described above. In one embodiment, the feature transformation submodule may first obtain a set of features by extracting a BoW from the interface object (e.g., “bill,” “address,” “pwd,” “zip,” etc.). Additionally or alternatively, in an embodiment, the feature transformation submodule may extract a list of tag attributes from interface objects such as HTML elements (e.g., title=“ . . . ”). Note that certain HTML elements, such as “input” elements, may provide higher accuracy since such input elements are more standardized than other classes of HTML tags. Additionally or alternatively, in an embodiment the feature transformation submodule may extract values of certain attributes. The values of attributes such as minlength and maxlength attributes may be useful in predicting the class of an interface object. For example, a form field with minlength=“5” may be suggestive of a zip code field. As another example, a form field with a maxlength=“1” may suggest a middle initial field. Thus, some of the features may be visible to the user, whereas other features may not.

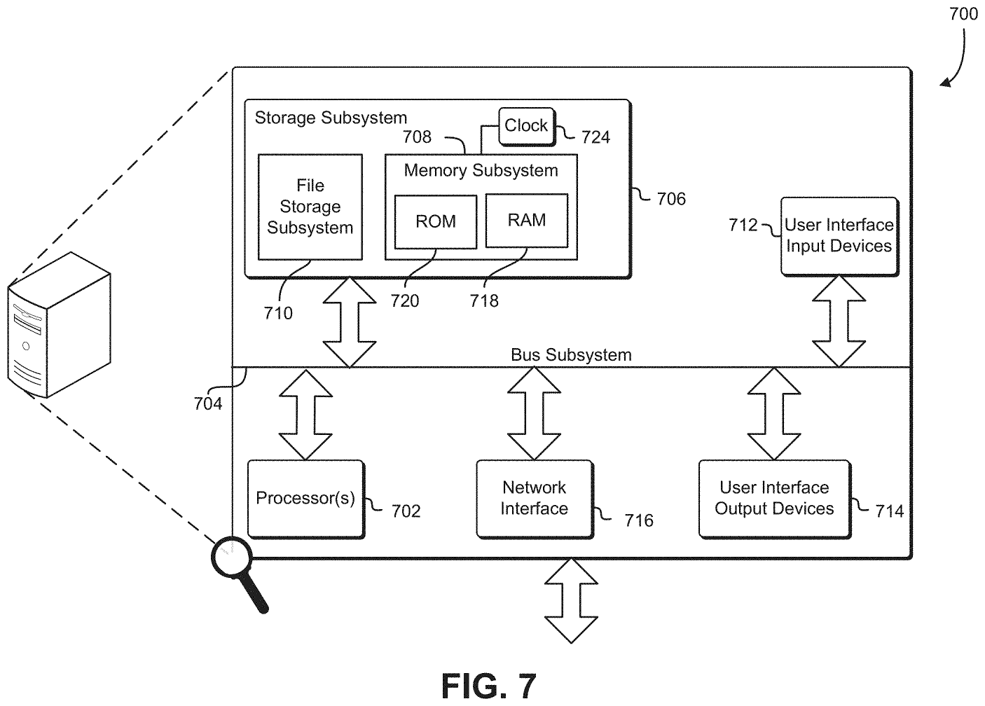

The client device 130, in some embodiments, may be embodied as a physical device and may be able to send and/or receive requests, messages, or information over an appropriate network. Examples of such devices include personal computers, cellular telephones, handheld messaging devices, laptop computers, tablet computing devices, set-top boxes, personal data assistants, embedded computer systems, electronic book readers, and the like, such as the computing device 700 described in conjunction with FIG. 7. Components used for such a device can depend at least in part upon the class of network and/or environment selected. Protocols and components for communicating via such a network are well known and will not be discussed in detail. Communication over the network can be enabled by wired or wireless connections and combinations thereof. The client device 130 may at least include a display whereby interfaces and elements of interest described in the present disclosure may be displayed to a user.

In embodiments, an application process runs on the client device 130 in a host application (such as within a browser or other application). The application process may monitor an interface for changes and may prompt a user for data to fill recognized forms on-the-fly. In some embodiments, the application process may require the host application to communicate with a service provider server backend and provide form-fill information, such as user data (e.g., name, address, etc.), in a standardized format. In some embodiments, the application process exposes an initialization function that is called with a hostname-specific set of selectors that indicates elements of interest, fetched by the host application from the service provider server backend. In embodiments, a callback may be executed when form fields are recognized. The callback may provide the names of recognized input fields as parameters and may expect the user data values to be returned, whereupon the host application may use the user data values as form-fill information to fill out the form. The client device 130 may automatically fill the field with the user's first name (as retrieved from memory or other storage). In some embodiments, the client device 130 asks the user for permission to auto-fill fields before doing so.

In this manner, techniques described in the present disclosure extend form-filling functionality to unknown forms by identifying input elements within interface forms from the properties of each element and its context within the interface form (e.g., text and other attributes around the element). The properties may be used to generate a dataset based on a cross product of a word and an attribute.

A form filling process running on the client device 130 may evaluate an interface that it is browsing and, for each element of interest, submit a classifier for the element of interest in the local assignment module 104. In return, the local assignment module 104 may provide the client device 130 with a list of possible labels (the class predictions 118) that the element of interest could be with their isolated probability of being that label.

For example, in an interface on the client device 130, the client device 130 may examine the interface to identify all of the elements of interest in the interface. The client device 130 may further look at the context of each element (e.g., the HTML properties of the element, classes, and properties of other elements adjacent to or at least near/proximate to the element, etc.) and use this context to generate a feature vector in the manner described in the present disclosure. For a given form element feature vector, the client device 130 may provide the feature vector to the local assignment module 104, and the local assignment module 104 may respond with output indicating that the form element has a 60% probability of being an email, a 30% probability of being a password, and a 10% probability of being a shipping address.

Additionally or alternatively, in embodiments, the features are based on text content of nearby elements (such as those whose tag name is “label”). Additionally or alternatively, in an embodiment, the features are based on the context of the element. For instance, this can be done by adding the text surrounding the HTML element of interest into the feature mixture. Near the elements can be determined by being within a threshold distance to the HTML element of interest in the DOM tree or pixel proximity on the rendered web page. Other embodiments may combine one or more of the methods described above (e.g., BoW, attributes, context text, etc.).

The obtained features may then be transformed into a set of feature vectors as described above, which may be used to train a classifier. For example, each feature vector from the set of training data 102 may be associated with a label or ground truth value that has been predetermined (e.g., “Shipping—Full Name” field, “Card Verification Value” field, etc.), which may then be specified to the machine learning model 108. In various embodiments, the machine learning model 108 may comprise at least one of a logistic model tree (LMT), a decision tree that decides which features to use, logistic regression, naïve Bayes classifier, a perceptron algorithm, an attention neural network, a support-vector machine, random forest, or some other classifier that receives a set of features and outputs confidence scores for a given set of labels.

The service provider 142 may be an entity that provides one or more computing resource services to its customers individually or as a combination of services of a distributed computer system. Services of the service provider 142 may be accessible to users via the network 144. Users of the services provided by the service provider 142 may communicate with the services via an interface, which may be a web services interface or other suitable interface. In some examples, a “service” refers to an executing computer software application that provides functionality to another computer software application. A service provided by a computing resource service provider may be one of one or more services configured to provide access to resources of a computer system of a service provider, including data processing, data storage, applications, interfaces, permissions, security policies, encryption and/or other such services. In the example 100, the local assignment module 104 may be provided as a service to users of services of the service provider 142, for example, to enable automated form-filling/completion as described in the present disclosure.

The service provider 142 may be an entity that hosts the local assignment module 104. The service provider 142 may be a different entity (e.g., third-party entity) from the provider that provides the interface that is auto-filled. In some embodiments, the service provider 142 provides the client device 130 with a software application that, upon execution by the client device 130, causes the client device 130 to fill in form fields according to the class predictions 118. In some embodiments, the application runs as a third-party plug-in/extension of a browser application on the client device 130, where the browser application displays the interface. Although the service provider 142 is depicted as hosting both the local assignment module 104 and the sequence assignment module 110, it is contemplated that, in various embodiments, either or both the local assignment module 104 or the sequence assignment module 110 could be hosted in whole or in part on the client device 130. For example, the client device 130 may submit source code containing elements of interest to the service provider 142, which may transform the source code using the feature transformation submodule 106, and the client device 130 may receive the feature vector 120 in response. The client device 130 may then input the feature vector 120 into its own trained machine learning model to obtain the class predictions 118.

In some embodiments, the services provided by the service provider 142 may include one or more interfaces that enable a user to submit requests via, for example, appropriately configured application programming interface (API) calls to the various services. Subsets of services may have corresponding individual interfaces in addition to, or as an alternative to, a common interface. In addition, each of the services may include one or more service interfaces that enable the services to access each other (e.g., to enable a virtual computer system to store data in or retrieve data from a data storage service). Each of the service interfaces may also provide secured and/or protected access to each other via encryption keys and/or other such secured and/or protected access methods, thereby enabling secure and/or protected access between them. Collections of services operating in concert as a distributed computer system may have a single front-end interface and/or multiple interfaces between the elements of the distributed computer system.

The network 144 may be a path of communication between the client device 130 and the service provider 142. Examples of the network 144 include the Internet, a local area network, a wide area network, and Wi-Fi.

FIG. 2 illustrates an example 200 of a well-performing trained classifier of an embodiment of the present disclosure. As illustrated in FIG. 2, the example 200 includes a set of label confidence scores 218 comprising a first data column “label,” which lists the possible interface object classes and a second data column “confidence,” which comprises a set of confidence scores of the various possible interface object classes for a first field 202A of fields 202A-02G in a form 234. The set of confidence scores may have been produced by a local assignment model such as the local assignment module 104 of FIG. 1. As can be seen, the set of confidence scores includes a confidence score indicating a probability (0.97569) that the first field 202A is a “Shipping—Full Name” field. The set of confidence scores also includes a confidence score indicating a probability (0.93667) that the first field 202A is a “Billing—Full Name” field, and another confidence score indicating a probability (0.76716) that the first field 202A is a “Shipping—First Name” field, and so on. The relatively high value of these confidence scores may be due in part to the text “Full name” above the first field 202A and/or other features of or around the first field 202A. Conversely, the set of confidence scores includes at the bottom a confidence score indicating a probability (0.11728) that the first field 202A is a “Billing—Address2” field; the relatively low confidence score for this field class may be due to the various features of the first field 202A, or in the vicinity of the first field 202A, being uncommon for the second billing address line.

As can be seen in FIG. 2, the most likely alternative (“Shipping—Full Name”) has been selected and assigned to the first field 202A. In embodiments, having selected the most likely field class for the first field 202A, a form-filling process running on a user's client device may fetch the corresponding form-fill information (e.g., full name of the user) and automatically enter it into the first field 202A in the interface. In embodiments, the form-filling process prompts the user for confirmation prior to automatically entering the selected label. In some implementations, if the prompted confirmation is denied by the user, the form-filling process may fetch alternate corresponding form-fill information for the next most likely alternative (e.g., “Billing—Full Name”) and prompt the user to confirm or deny filling in the form field with the next-most likely alternative. Note that although the form 234 is depicted in FIG. 2 only with text fields and a submit button, it is contemplated that the techniques of the present disclosure may be implemented with various other classes of form fields, such as drop-down boxes, textarea boxes, radio buttons, checkboxes, password fields, and the like.

The form 234 may be a form implemented in an interface accessible by a client device, such as the client device 130 of FIG. 1. For example, the form 234 may be a HTML form on a web page that allows a user to enter data, via the client device, into the form that may be subsequently transmitted to a server of an entity for processing. In embodiments, the form 234 and/or interface may be viewable through a software application, such as a browser, running on the client device. The software application may be provided by another third-party entity. In various embodiments, the executable software code (e.g., JavaScript code) of the form-filling process may be injected by the software application into the source code of the interface (e.g., such as by a plug-in or extension or natively by the software application). In this manner, the form-filling process may have access to examine and extract various features from the interface objects and the interface, transform them into a feature vector or other value or values suitable for input to a trained machine learning model, and/or transmit such data to the machine learning model.

For example, a client device may execute the injected software code comprising the form-filling process to analyze an interface to identify elements of interest. In an embodiment, if the form-filling process detects form fields that it recognizes (e.g., with a confidence score at a value relative to a threshold, such as meeting or exceeding the threshold), the form-filling process causes the client device to prompt the user (e.g., with a pop-up, such as “Automatically fill in the fields?” in one embodiment). In another embodiment, the form-filling process waits until the user gives focus to one of the input elements, and then the form-filling process determines to prompt the user and/or automatically fill in the input fields. In some embodiments, the form-filling process prompts the user whether to automatically fill in the input fields one by one, whereas in some other the form-filling process prompts the user one time whether to automatically fill in all of the input fields (e.g., all at once).

The fields 202A-02G may be any of various elements usable by a user of a client device to enter data. Although depicted as text boxes, it is contemplated that the fields 202A-02G may alternatively be an email field, a number field, a password field, a radio button, a file select control, a textarea field, a drop-down box, a combo box, a list box, a multi-select box, or the like. In some embodiments, the fields 202A-02G may be HTML, elements.

The set of label confidence scores 218 may be a set of data containing all possible input classes (e.g., labels) for a form field and the confidence scores for each of the possible input classes. Alternatively, the set of data may only include input classes with the confidence scores indicating the top N likeliest input classes.

It is contemplated that techniques of the present disclosure may be applied to other endeavors beyond form-filling. In some embodiments, techniques of the present disclosure are used for predictive text; for example, if a user enters “The journey of a thousand miles” and begins typing the next word beginning with a letter “b,” the process of the present disclosure may, based on the previous words that were entered, features of the form field, and words beginning with the letter “b” in the past that the machine learning model has been trained on, autocomplete the word as “begins,” and may prompt the user whether to autocomplete with subsequent words, “with one step.”

Techniques of the present disclosure may additionally or alternatively be used to detect interface classes. For example, if the system of the present disclosure evaluates the elements in the interface and determines, with confidence scores at values relative to (e.g., meets, exceeds, etc.) to a threshold, the presence of a card verification value field, a name field, and an address field, the system may determine with relative confidence that the interface is a payment page. On the other hand, if the system evaluates the elements and detects images of one or more products and a button element having a value of “Add to Cart,” the system may determine with relative confidence that the interface is a product page. The system may then take different actions based on the particular interface class; for example, the system may notify the user (e.g., via the client device of the user) that it is time to reorder the product on the page.

FIG. 3 illustrates an example 300 of transforming features of an interface into a feature vector, which may then be provided to a machine learning model trained to determine classes of interface objects based on features, according to various embodiments. Specifically, FIG. 3 depicts a local assignment module 304 that receives a set of features 302 of an interface object as input to a feature transformation submodule 306, which transforms the set of features 302 into a feature vector 320. In the example 300, the feature vector 320 is provided as input to a machine learning model 322, which may output a predicted class 324 or a set of confidence scores for multiple possible classes (see the set of label confidence scores 218 of FIG. 2) for the interface object.

The set of features 302 may be a set of attributes of the interface object and/or a set of attributes of nearby interface objects. For example, an attribute of the set of features 302 may be the HTML element class (e.g., “list item,” “ordered list,” “unordered list,” “anchor,” “image,” “label,” “button,” “checkbox,” “radio,” “drop-down,” “text,” “textarea,” “password,” “file,” “submit,” etc.). Another attribute of the set of features 302 may be a name or ID of the interface object (e.g., “address-ui-checkout-form,” “searchInput,” “email,” “AddressLine2,” “FormField_5,” “Last Name,” “MI,” etc.). Another attribute of the set of features 302 may be a value or default value of the interface object (e.g., “First Name,” “1,” “206,” “0000 0000 0000 0000,” “( ) -,” etc.). Still other attributes of the set of features 302 may be attributes of other interface elements that are near (e.g., within a threshold number of nodes from the interface element in the DOM tree). The attributes may be identified by analyzing the source code and/or state information of the interface to construct a data representation of the interface, such as a document object model that represents the interface objects and in a hierarchical tree structure. The set of features 302 may be the leaf nodes descending from an interface object node of the interface DOM.

The local assignment module 304 may be a software or hardware module for classifying interface objects. The local assignment module may be similar to the local assignment module 104 of FIG. 1.

The feature transformation submodule 306 may be a submodule of the local assignment module 304 that transforms attributes of interface object and/or attributes of interface objects near to the interface object into a token or feature vector for input into the machine learning model 322. For example, the feature transformation submodule 306 may process the set of features 302. The plurality of the object hierarchy paths may then be analyzed to identify the presence of interface element features the machine learning model 322 has been trained upon, and may then generate the feature vector 320.

The feature transformation submodule 306 may transform the set of features 302 according to a bag-of-words (BoW) model. For example, the text and attributes of the element of interest and/or text and attributes of nearby elements may be represented as a bag (multiset) of its words (also referred to in the present disclosure as features of the element of interest). Features that are potentially present in the BoW could be an ID of the element of interest, the name of the element of interest, and so on.

The feature vector 320 may be a token or vector that is expressed in a format usable as input to the machine learning model 322. In some implementations, the feature vector may be generated based on which of a set of possible features that the machine learning model has been trained with are present within the set of features 302. In such an implementation, if a possible feature is within the set of features 302 a “1” may be added to the feature vector; if not, a “0” may be added to the feature vector. The feature vector may be utilized as an input to the machine learning model 322.

The machine learning model 322 may comprise one or more neural networks or other machine learning model that may be trained to classify an interface object based on its attributes and/or attributes of interface objects near to the interface object. The machine learning model 322 may output the predicted class 324.

In some implementations, the predicted class 324 may be a suggested most-likely classification for the interface object. In other embodiments, the predicted class 324 may be a set of confidence scores representing probabilities that the interface object corresponds to different classifications. For example, if the interface object is a text box with certain features, the predicted class 324 may be a set of confidence scores indicating a 30% probability that the text box is an address field, a 11% probability that the text box is a first name field, a 2% probability that the text box is a zip code field, and so on. The highest confidence of the set of confidence scores may indicate which of the interface object classes the machine learning model 322 predicts is most likely the correct one.

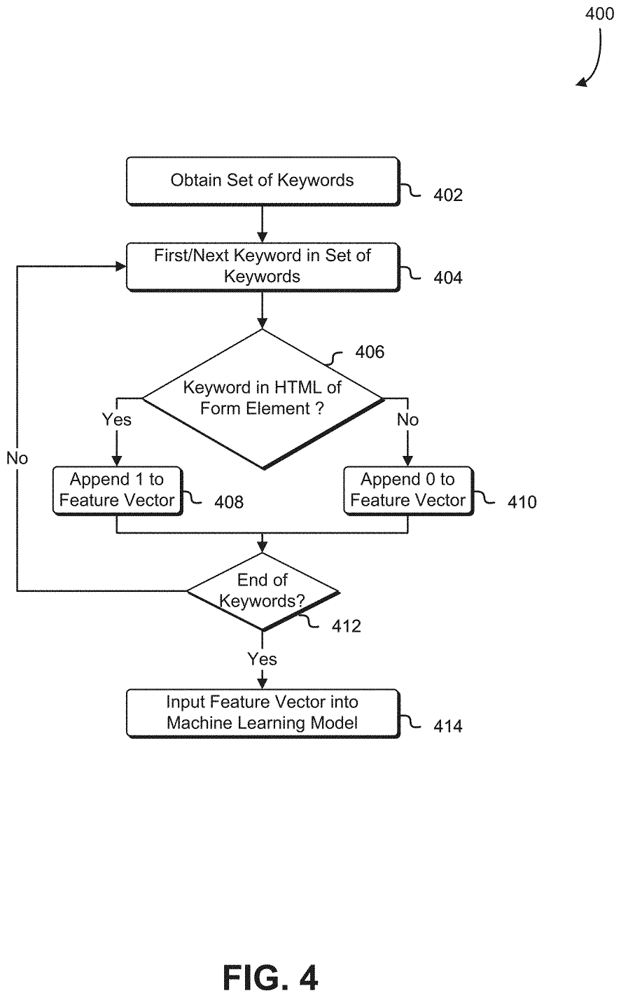

FIG. 4 is a flowchart illustrating an example of a process 400 for generating a feature vector for input to a machine learning model, in accordance with various embodiments. Some or all of the process 400 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 400 may be performed by any suitable system, such as the computing device 700 of FIG. 7. The process 400 includes a series of operations wherein a set of possible keywords for an element of interest is obtained and, for each possible keyword in the set, a 1 or 0 is appended to a feature vector depending on whether the keyword is found in the source code of the element of interest. Then, the feature vector is provided to a machine learning model (such as the machine learning model 108 and the machine learning model 322 of FIGS. 1 and 3, respectively).

In 402, the system performing the process 400 may obtain a set of possible keywords for an element of interest in an interface. The set of possible keywords may have been predetermined by a human operator based on keywords determined to be relevant to identifying a classification of an element of interest. In 404, the system performing the process 400 may begin to iterate through the set of keywords by selecting the first or next keyword in the set. In 406, the system may determine if the currently selected keyword occurs within the source code of the element of interest and/or within text or source code of neighboring elements of interest. If so, the system may, in 408, append the value of 1 (or otherwise indicate that a match was found, depending on implementation) to the feature vector. If not, the system may, in 410, append the value of 0 (or otherwise indicate that a match was not found, depending on implementation) to the feature vector.

In 412, the system performing the process 400 may determine whether the keyword is the last keyword of the set of keywords. If not, the system may return to 404 to repeat 404-12 for each keyword in the set of keywords. In 414, the system inputs the feature vector into a machine learning model. Inputting a feature vector generated in this manner along with a label corresponding to a classification of the element of interest, a machine learning model learning may be trained to classify elements of interest based on such feature vector. Likewise, inputting a feature vector generated in this manner may cause a trained machine learning model to output a predicted classification, or confidence scores of different possible classifications such as the set of label confidence scores 218 of FIG. 2, for the element of interest.

FIG. 5 illustrates an example data table 500 of training data for a machine learning model, such as the machine learning model 108 of FIG. 1. As illustrated in FIG. 5, each of the rows 552 of the example data table 500 represent an actual interface object (of the class that a machine learning model such as the machine learning model 108 is being trained to identify) implemented in an interface (e.g., a web page, mobile telephone application, etc.) of entity (e.g., a particular provider of goods or services). The labelName column 548 may be a column containing the known label/ground truth value for that interface object. The value in the labelName column 548 may be determined or confirmed by a human operator. The feature columns 550 may be feature values such as attribute values and/or binary indications of the presence or absence of a particular attribute within or near to the interface object. For example, the record for a first interface object in the example data table 500 shows that it is a “Coupon-Input” field, is the 3rd interface object of interest in the interface (“order:2,” where “0” would indicate the first in the sequence), has 0 elements of interest following it in the interface where the interface itself has “7” elements of interest, has a height of 60 pixels and a width of 242 pixels, and is located in the interface at an XY position of (145, 1598). The record further indicates that the first interface object does not include (as indicated by “0”) attributes of maxlength=“3,” maxlength=“4,” maxlength=“12” maxlength, minlength, autofocus, disabled, readonly, required, additionalName, “addr,” “addr1,” “addr2,” “address,” and so on.

The values in the feature columns 550 of the example data table 500 may be combined into a feature vector, such as the feature vector 320 of FIG. 3, which may then be used to train the machine learning model 322. Prior to training the machine learning model, the rows 552 and columns 546 of the example data table 500 may be filled with the values for the features and labels of elements of interest. When a client device running the form-filling process of the present disclosure evaluates an interface form, the process may, for each form field, similarly generate a feature vector based on the values and/or presence of the features in or around the form field. The generated feature vector may be an array of numbers (e.g., “011001150 . . . ”) that the form-filling process provides to the trained machine learning model. In response, the trained machine learning model may output a data table similar to the set of label confidence scores 218 of FIG. 2 with confidence scores associated with each distinct label from the set of labels in the labelName column 548.

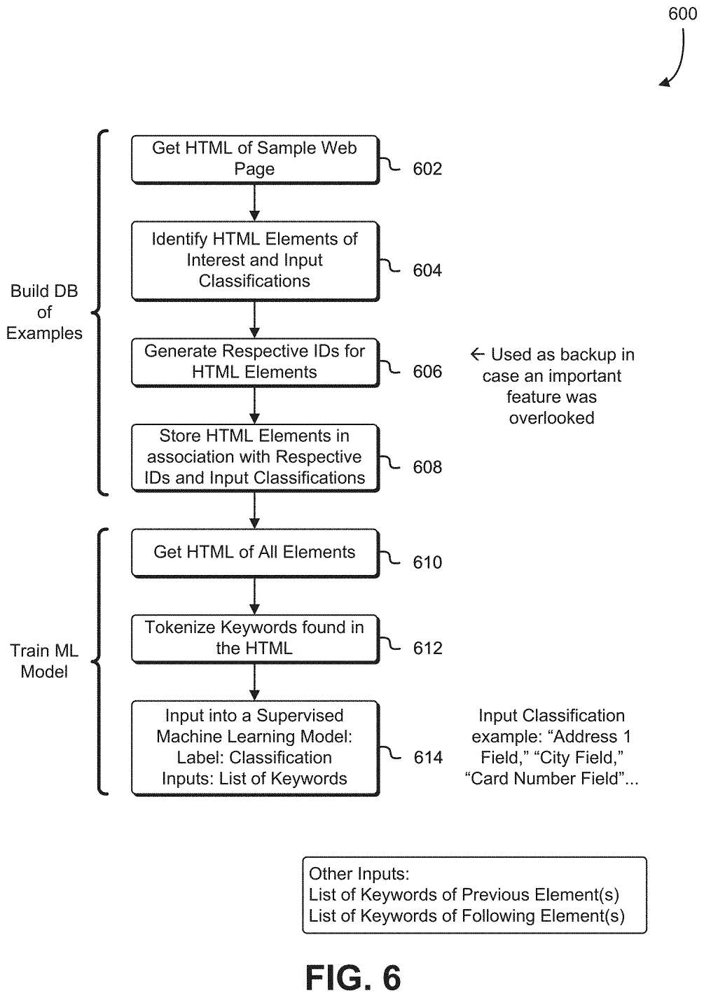

FIG. 6 is a flowchart illustrating an example of a process 600 for training a machine learning model to classify interface object classes in accordance with various embodiments. Some or all of the process 600 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 700 of FIG. 7. The process 600 includes a series of operations wherein the system performing the process builds a database of examples of elements of interest, tokenizes the examples, and inputs the tokenized data into the supervised machine learning model being trained.

In 602, the system performing the process 600 obtains source code of a web page containing elements of interest. In embodiments, the web page is one of a plurality of web pages in training data such as in the example data table 500 of FIG. 5. The elements of interest may potentially be form elements or other HTML elements.

In 604, the system performing the process 600 evaluates the web page and identifies elements of interest. In embodiments, the system traverses a DOM tree of the web page to find the elements of interest. The system may, for example, be configured to identify HTML INPUT elements as elements of interest, or may utilize some other criteria for distinguishing elements of interest from other HTML code in the web page. Additionally or alternatively, a human operator may curate the elements of the web page and identify the elements of interest and/or eliminate any elements incorrectly identified as being elements of interest. The operator may assign labels to the elements of interest indicating their classification (e.g., zip code field, middle initial field, address field, etc.).

In 606, the system performing the process 600 generates element IDs for each of the elements of interest. The element IDs may be suitable for distinguishing each of the elements from each other in a database table.

Correspondingly, in 608, the system performing the process 600 stores the source code (e.g., HTML code) of the elements of interest in association with their respective IDs and classifications. In some embodiments, the system additionally stores source code of HTML elements adjacent to or near/proximate to the element of interest (e.g., five preceding and five succeeding HTML elements and attributes, including intervening text) in association with the element ID. In this manner, the context of each element of interest in the training data can be preserved and utilized later as needed.

Having stored the elements of interest and their relevant data in 608, in 610, the system performing the process 600 begins the process of training the machine learning model and obtains the source code of the elements of interest from storage.

In 612, the system performing the process 600 tokenizes the source code into a format suitable for input into the machine learning model. Tokenization may involve transforming information about the element of interest and/or surrounding context into a feature vector, such as the feature vector 320 of FIG. 3. This transformation may include performing multiple regular expression queries against the element of interest source code in search of a keyword, and appending a 1 or 0 (indicating presence or absence of the feature of the keyword, or vice versa) to the feature vector.

In 614, the system performing the process 600 may input the feature vector into the machine learning model being trained along with the label (that indicates the element of interest classification) into the machine learning model. Additional inputs may include tokenizations of keywords from nearby elements previous to and following the element of interest. In implementations, the tokenizations of the keywords from nearby elements may be included in the feature vector. Note that one or more of the operations performed in 602-14 may be performed in various orders and combinations, including in parallel.

Note that in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 7 is an illustrative, simplified block diagram of a computing device 700 that can be used to practice at least one embodiment of the present disclosure. In various embodiments, the computing device 700 includes any appropriate device operable to send and/or receive requests, messages, or information over an appropriate network and convey information back to a user of the device. The computing device 700 may be used to implement any of the systems illustrated and described above. For example, the computing device 700 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 700 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 7, the computing device 700 may include one or more processors 702 that, in embodiments, communicate with and are operatively coupled to a number of peripheral subsystems via a bus subsystem. In some embodiments, these peripheral subsystems include a storage subsystem 706, comprising a memory subsystem 708 and a file/disk storage subsystem 710, one or more user interface input devices 712, one or more user interface output devices 714, and a network interface subsystem 716. Such storage subsystem 706 may be used for temporary or long-term storage of information.

In some embodiments, the bus subsystem 704 may provide a mechanism for enabling the various components and subsystems of computing device 700 to communicate with each other as intended. Although the bus subsystem 704 is shown schematically as a single bus, alternative embodiments of the bus subsystem utilize multiple buses. The network interface subsystem 716 may provide an interface to other computing devices and networks. The network interface subsystem 716 may serve as an interface for receiving data from and transmitting data to other systems from the computing device 700. In some embodiments, the bus subsystem 704 is utilized for communicating data such as details, search terms, and so on. In an embodiment, the network interface subsystem 716 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well-known and will not be discussed in detail. In an embodiment, communication via the network interface subsystem 716 is enabled by wired and/or wireless connections and combinations thereof.

In some embodiments, the user interface input devices 712 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 700. In some embodiments, the one or more user interface output devices 714 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 700. The one or more user interface output devices 714 can be used, for example, to present user interfaces to facilitate user interaction with applications performing processes described and variations therein, when such interaction may be appropriate.

In some embodiments, the storage subsystem 706 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 706. These application modules or instructions can be executed by the one or more processors 702. In various embodiments, the storage subsystem 706 additionally provides a repository for storing data used in accordance with the present disclosure. In some embodiments, the storage subsystem 706 comprises a memory subsystem 708 and a file/disk storage subsystem 710.

In embodiments, the memory subsystem 708 includes a number of memories, such as a main random access memory (RAM) 718 for storage of instructions and data during program execution and/or a read only memory (ROM) 720, in which fixed instructions can be stored. In some embodiments, the file/disk storage subsystem 710 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 700 includes at least one local clock 724. The at least one local clock 724, in some embodiments, is a counter that represents the number of ticks that have transpired from a particular starting date and, in some embodiments, is located integrally within the computing device 700. In various embodiments, the at least one local clock 724 is used to synchronize data transfers in the processors for the computing device 700 and the subsystems included therein at specific clock pulses and can be used to coordinate synchronous operations between the computing device 700 and other systems in a data center. In another embodiment, the local clock is a programmable interval timer.

The computing device 700 could be any of a variety of types, including a portable computer device, tablet computer, a workstation, or any other device described below. Additionally, the computing device 700 can include another device that, in some embodiments, can be connected to the computing device 700 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 700 for processing. Due to the ever-changing nature of computers and networks, the description of the computing device 700 depicted in FIG. 7 is intended only as a specific example for purposes of illustrating the preferred embodiment of the device. Many other configurations having more or fewer components than the system depicted in FIG. 7 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 700 may include any appropriate hardware, software and firmware for integrating with a data store as needed to execute aspects of one or more applications for the computing device 700 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 700 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 700 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 700 may provide the content in one or more forms including, but not limited to, forms that are perceptible to the user audibly, visually, and/or through other senses. The handling of requests and responses, as well as the delivery of content, in an embodiment, is handled by the computing device 700 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 700 typically will include an operating system that provides executable program instructions for the general administration and operation of the computing device 700 and includes a computer-readable storage medium (e.g., a hard disk, random access memory (RAM), read only memory (ROM), etc.) storing instructions that if executed (e.g., as a result of being executed) by a processor of the computing device 700 cause or otherwise allow the computing device 700 to perform its intended functions (e.g., the functions are performed as a result of one or more processors of the computing device 700 executing instructions stored on a computer-readable storage medium).

In an embodiment, the computing device 700 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 700 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, JavaScript, or TCL, as well as combinations thereof. In an embodiment, the computing device 700 is capable of storing, retrieving, and accessing structured or unstructured data. In an embodiment, computing device 700 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
obtaining:
HyperText Markup Language (HTML) code of a form element in a web page; and
a classification of the form element;
tokenizing the HTML code of the form element to produce a vector representing which keywords of a set of possible keywords are present within the HTML code; and
producing a trained machine learning model by:
providing, to a supervised machine learning model, the classification of the form element as label input; and
providing, to the supervised machine learning model, the vector as input.

2. The computer-implemented method of claim 1, further comprising:
implementing the trained machine learning model to predict a classification of a second element in a second web page by:
obtaining second HTML code of the second element;
tokenizing the second HTML code of the second element to produce a second set of keywords;
transforming the second set of keywords into a second vector;
in response to providing the second vector as input to the trained machine learning model, receiving a prediction of the classification of the second element; and
inputting, into the second element in the second web page, a value in accordance with the prediction.

3. The computer-implemented method of claim 1, wherein tokenizing the HTML code includes generating the set of keywords by splitting the HTML code according to one or more separator characters.

4. The computer-implemented method of claim 1, wherein tokenizing the HTML, code includes further splitting the set of keywords into strings of a fixed number of characters according to a moving window.

5. A system, comprising:
one or more processors; and
memory including computer-executable instructions that, if executed by the one or more processors, cause the system to:
obtain:
source code of a form element of a web form; and
a predetermined data classification of the form element;
generate a vector based at least in part on a transformation of a set of keywords derived from the source code; and
train a machine learning model to predict data categories of form elements by providing, to the machine learning model, the predetermined data classification and the vector.

6. The system of claim 5, wherein:
the computer-executable instructions further include instructions that further cause the system to:
obtain additional source code of another form element proximate to the form element; and
transform the additional source code into an additional set of keywords; and
the computer-executable instructions that cause the system to generate the vector further cause the system to generate the vector based at least in part on a transformation of both the set of keywords and the additional set of keywords.

7. The system of claim 5, wherein the computer-executable instructions that cause the system to generate the vector further include instructions that cause the system to further generate the vector based at least in part on a quantity of form elements in the web form.

8. The system of claim 5, wherein the computer-executable instructions that cause the system to generate the vector further include instructions that further cause the system to generate the vector based at least in part on a character limit of the form element.

9. The system of claim 5, wherein the computer-executable instructions further include instructions that further cause the system to:
receive, from a client device, a request for form-fill information, the request identifying a user and including a feature a feature vector of a web form element;
receive, as a result of inputting the feature vector into the machine learning model, an indication of a classification of the web form element;
obtain, from a data store, the form-fill information that corresponds to the user and the classification; and
provide the form-fill information to the client device in response to the request.

10. The system of claim 9, wherein the computer-executable instructions that cause the system to provide the form-fill information further cause the client device to prompt a user of the client device whether to populate the web form element with the form-fill information.

11. The system of claim 5, wherein the computer-executable instructions that further include instructions that further cause the system to:
receive, from a client device, an indication that a web form element corresponds to a classification different from an initial classification determined by the machine learning model for the form element; and
retrain the machine learning model based on the indication.

12. The system of claim 11, wherein the indication indicates that a user of the client device entered, as input to the web form element, data corresponding to the classification different from the initial classification.

13. A non-transitory computer-readable storage medium storing thereon executable instructions that, if executed by one or more processors of a computer system, cause the computer system to at least:
obtain:
source code of an element located in an interface; and
a class of data the element is intended to receive;
generate a set of keywords from the source code;
transform the set of keywords into a vector; and
produce a trained machine learning model by causing the computer system to:
provide, to a supervised machine learning model, the class of data as label input; and
provide, to the supervised machine learning model, the vector as data input.

14. The non-transitory computer-readable storage medium of claim 13, wherein the executable instructions further include instructions that further cause the computer system to:
implement the trained machine learning model to predict a classification of a second element in a second interface by causing the computer system to:
obtain second source code of the second element;
transform the second source code into a second vector;
in response to providing the second vector as input to the trained machine learning model, receive a prediction of the class of data of the second element; and
input, into the second element in the second interface, a value in accordance with the prediction.

15. The non-transitory computer-readable storage medium of claim 13, wherein the executable instructions that cause the computer system to generate the set of keywords include instructions that cause the computer system to generate the set of keywords by splitting the source code according to one or more separator characters.

16. The non-transitory computer-readable storage medium of claim 13, wherein the executable instructions that cause the computer system to generate the set of keywords include instructions that cause the computer system to generate a set of fixed-length strings.

17. The non-transitory computer-readable storage medium of claim 13, wherein the executable instructions further include instructions that further cause the computer system to:
receive, from a client device, an indication that a previously uncategorized element corresponds to a certain classification of data;
generate an additional vector based on source code of the previously uncategorized element; and
update the trained machine learning model based on the additional vector.

18. The non-transitory computer-readable storage medium of claim 13, wherein the executable instructions further cause the computer system to:
receive, from a client device, source code of a web form;
identify a set of elements of the web form, disregarding elements of the web form that would not be visible to a user of the client device;
determine a set of auto-fill information for the web form; and
cause, by providing the client device with the set of auto-fill information, the client device to auto-fill the set of elements of the web form with the set of auto-fill information.

19. The non-transitory computer-readable storage medium of claim 18, wherein the vector further includes a value indicating a geographical region associated with the web form.

20. The non-transitory computer-readable storage medium of claim 18, wherein the executable instructions that cause the computer system to determine the set of auto-fill information include instructions that cause the computer system to, for each form element of the set of elements:
transform features of the form element into a feature vector;
in response to providing the feature vector to the trained machine learning model, receive an estimation of the class of data of the form element; and
in accordance with the estimation, fetch auto-fill information that corresponds to the class of data and a user of the client device.
